(19) United States
(12) Patent Application Publication
(10) Pub. No.: US 2025/0031665 A1
(43) Pub. Date: Jan. 30, 2025

(54) PET SLOW FOOD TABLEWARE

(71) Applicant: WELLFINE SILICONE PRODUCTS CO., LTD., DONGGUAN (CN)

(72) Inventors: FENG LIU, DONGGUAN (CN); HONGWEI ZHANG, DONGGUAN (CN)

(21) Appl. No.: 18/429,550

(22) Filed: Feb. 1, 2024

(30) Foreign Application Priority Data
Jul. 28, 2023 (CN) 202322027324.1

(51) Int. Cl. A01K 5/02; A01K 5/01

(52) U.S. Cl. CPC A01K 5/0225; A01K 5/0135

(57) ABSTRACT

A pet slow food tableware includes a food tray including a body for receiving pet food, a plurality of protrusions formed at an inner surface of the body, a feeding bin installed above the food tray and including a receiving room for receiving the food to be put in, an inlet for adding pet food to the feeding bin therefrom; a food leakage hole formed on a bottom of the feeding bin that the food is to flow out of the feeding bin to the food tray. When using the improved slow food tableware, pet food is stored in the feeding bin through the inlet, and the food flows from the food leakage hole to the food tray for pets to eat. The feeding bin is flexibly installed above the food tray, which can train pets to shake the feeding bin to replenish food for themselves.

### BACKGROUND

### Technical Field

The present disclosure generally relates to the field of pet supplies, and especially relates to a pet slow food tableware.

### Description of Related Art

Pets are usually unrestrained when eating food, and their eating speeds are fast, result in making them prone to choking or overeating, which can affect their digestion. Therefore, a slow food tableware has emerged in the market, and some interference structures are designed on the slow food tableware to slow down the eating speed that pets eat food. However, this type of slow food tableware usually only has a separate bowl, which usually accommodates an amount of food that pets need to eat for a meal, without a storage space being arranged on the conventional slow food tableware, so that it is difficult to replenish food for pets.

### SUMMARY

The technical problems to be solved: in view of the shortcomings of the related art, the present disclosure provides a pet slow food tableware which can store grain therein.

The technical solution adopted for solving technical problems of the present disclosure is: a pet slow food tableware according to an embodiment of the present disclosure includes a food tray including a body configured to receive pet food for pets, and a plurality of protrusions formed at an inner surface of the body; and a feeding bin installed above the food tray and including a receiving room for receiving the food to be put in, wherein the feeding bin includes an inlet so that pet food can be added to the feeding bin from the inlet, and a food leakage hole formed on a bottom of the feeding bin so that the food is to flow out of the feeding bin to the food tray.

Wherein the body of the food tray includes an elastic post extending upwardly from a bottom of the feeding bin.

Wherein an inserting hole is formed on the bottom of the feeding bin so that the elastic post inserts into the inserting hole; and the elastic post includes a locking portion to stably fix the feeding bin.

Wherein the feeding bin includes a baffle adapted to the food leakage hole.

Wherein the feeding bin includes a plurality of food leakage holes with different sizes; and the baffle corresponding to each of the plurality of food leakage holes is a disposable design and connected to the corresponding food leakage hole through a fragile wire.

Wherein the baffle is connected to a circular member slidably sleeved around an outer of the elastic post.

Wherein a size of the inlet is less than a size that is required for feeding pets.

Wherein the inlet is formed on a top surface of the feeding bin, the inlet including a hole position formed at a middle of the inlet, and a plurality of wiring grooves radiating towards the periphery of the hole position.

Wherein the pet slow food tableware further includes a cover covered on the inlet.

Wherein each of the plurality of protrusions includes two arc plates crossed to each other.

The present disclosure provides the advantages as below: when using the improved slow food tableware of the present disclosure, pet food is stored in the feeding bin through the inlet, and the food flows from the food leakage hole to the food tray for pets to eat. The feeding bin is flexibly installed above the food tray, which can train pets to shake the feeding bin to replenish food for themselves.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. The same reference numerals in the accompanying drawings indicate the same or similar components or parts, one of ordinary skill in the related art should understand that these drawings are not necessarily drawn to scale.

FIG. 1 is a schematic view of a pet slow food tableware in accordance with a first embodiment of the present disclosure.

FIG. 2 is a schematic view of a feeding bin of the pet slow food tableware of FIG. 1.

FIG. 3 is a schematic view of a pet slow food tableware in accordance with a second embodiment of the present disclosure.

FIG. 4 is an exploded, schematic view of the pet slow food tableware of FIG. 3.

FIG. 5 is similar to FIG. 4, but shown from another view.

FIG. 6 is a schematic view of a pet slow food tableware in accordance with a third embodiment of the present disclosure.

FIG. 7 is an exploded, schematic view of the pet slow food tableware of FIG. 6.

The element labels according to the embodiment of the present disclosure shown as below:
1 food tray, 10 protrusion, 100 arc plate, 101 elastic post, 102 locking portion, 103 sucking disc, 2 feeding bin, 20 inlet, 21 cover, 200 hole position, 201 wiring groove, 21 food leakage hole, 22 inserting hole, 23 baffle, 24 circular member.

### DETAILED DESCRIPTION

In order to more clearly understand the technical solution hereinafter in embodiments of the present disclosure, reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples.

According to the described embodiment of the present disclosure, all other embodiments obtained by one of ordinary skill in the related art without the need for a creative labor are within the protection scope of the present disclosure. Unless defined otherwise, the technical terms or scientific terms used for the present disclosure shall be a general meaning commonly understood by those having ordinary skill in the related art to which the present disclosure is applied.

In the description of the present disclosure, it needs to be understood that the terms mentioned below: the terms such as “first” and “second” shown in the specification are only used to describe, but not indicated that the elements of the present disclosure is important or represented the amount of the elements. That is, the features limited by the terms of “first” and “second” may explicitly or implicitly include one or more features. Similar, in the description of the present disclosure, the meaning of the term “one”, “a” and “the” don't indicate a quantitative limit, but indicate that it includes at least one unless it is specifically illustrated. Furthermore, the terms such as “include”, “including”, “comprising” and “comprise” and the like means that elements or items in front of such term is intended to cover the elements or objects appeared the list behind the term and its equivalent, without excluding other elements or items. In the description of the present disclosure, except where specifically otherwise illustrated or limited, the terms “install”, “connect”, “link” and “fix” used herein should be understood in a broad perceive. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure. In addition, the terms such as “upper”, “below”, “left”, and “right”, etc, are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

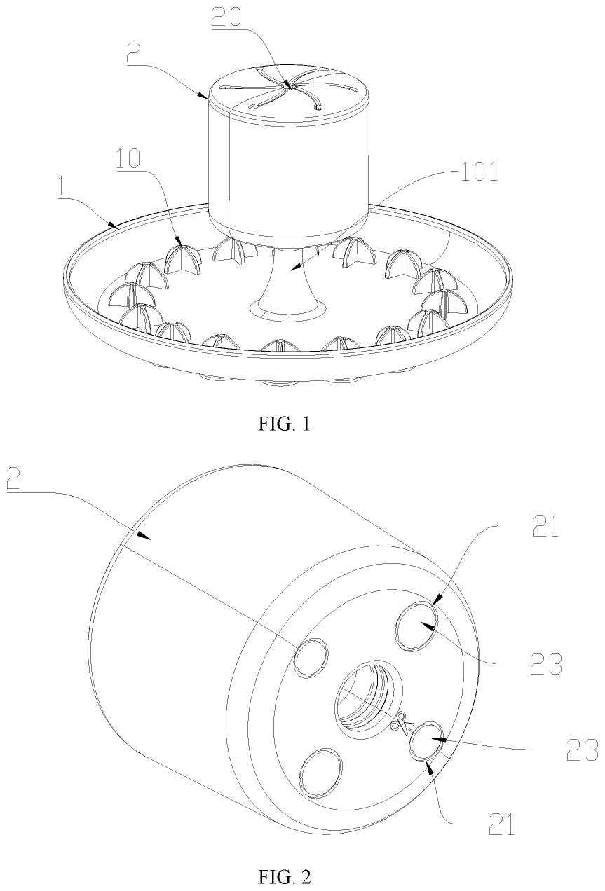

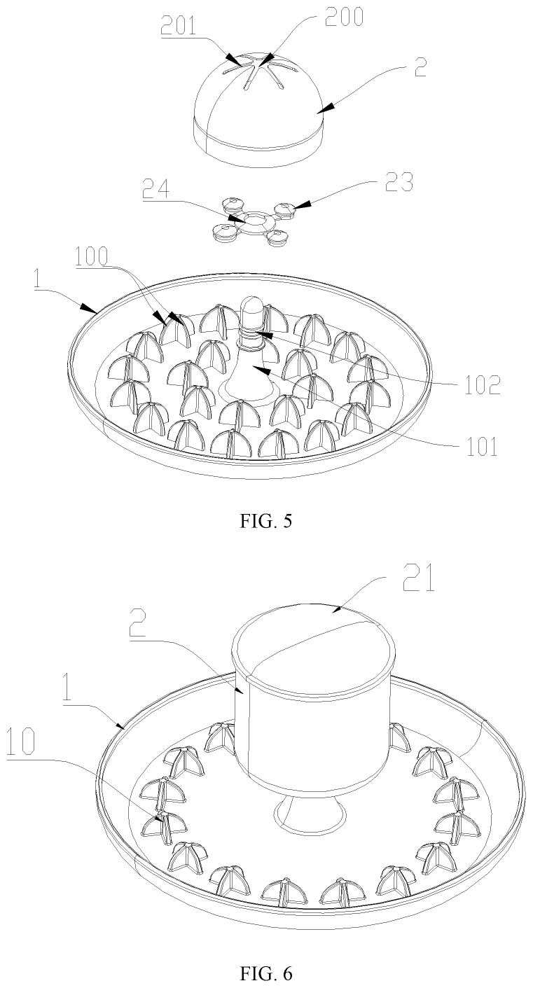

Referring to FIGS. 1-5, a pet slow food tableware according to an embodiment of the present disclosure includes a food tray 1 including a body configured to receive pet food for pets, and a plurality of protrusions 10 formed at an inner surface of the body; and a feeding bin 2 installed above the food tray 1 and including a receiving room for receiving the food to be put in, wherein the feeding bin 2 includes an inlet 20 so that pet food can be added to the feeding bin 2 from the inlet 20, and a food leakage hole 21 formed on a bottom of the feeding bin 2 so that the food is to flow out of the feeding bin 2 to the food tray 1.

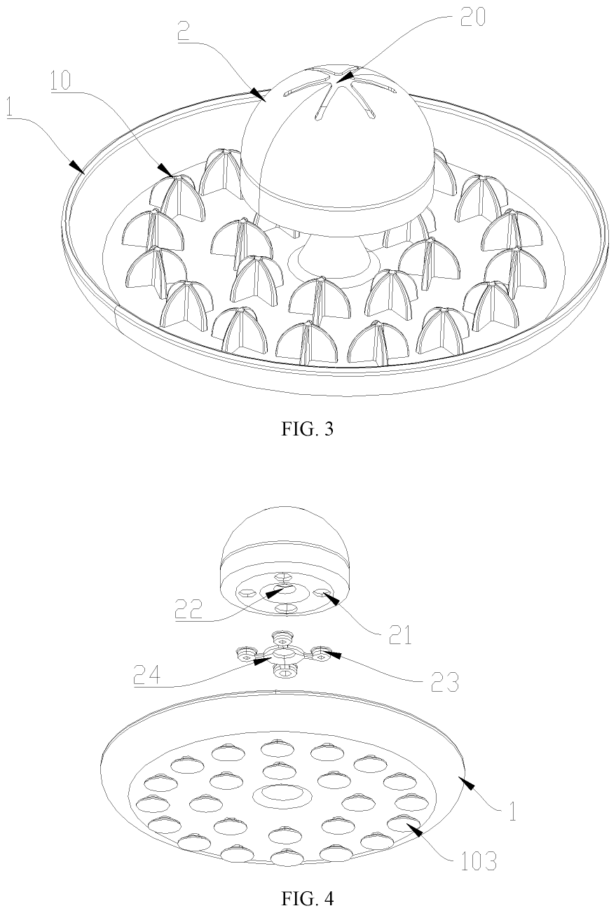

The feeding bin 2 is generally in a relatively closed shape with a certain amount of storage spaces therein, such as a cylindrical shape and a mushroom head shape as shown in FIG. 1 and FIG. 3. Users can put pet food into the feeding bin 2 through the inlet 20. When there are no baffles in the feeding bin 2, during putting pet food into the feeding bin 2, some pet food will flow from the food leakage hole 21 to the food tray 1, and there are still a large amount of pet food stored in the feeding bin 2, especially granular pet food, which is prone to crowding and interference with each other and getting stuck in the leakage hole 21, and thus stored in the feeding bin 2. When it is necessary to replenish food into the food tray 1, users can hold the tableware and shake the tableware to allow pet food flow out of the feeding bin 2, and the pet food in the food tray 1 can be more evenly distributed.

In some embodiments of the present disclosure, the body of the food tray 1 includes an elastic post 101 extending upwardly from a bottom of the feeding bin 2. The elastic post 101 can be fixedly connected to the feeding bin 2. Preferably, an inserting hole 22 is formed at a bottom of the feeding bin 2 and the elastic post 101 is inserted into the inserting hole 22, so that both the elastic post 101 and the inserting hole 22 can be disassembled with each other. The elastic post 101 is usually made of a silicone material and integrated with the body. Although the pet food stored in the feeding bin 2 can flow out through the food leakage hole 21, the granular pet food become crowded and often get stuck, so it needs to shake the pet slow food tableware to send out all the remaining pet food. The feeding bin 2 is installed on the elastic post 101. If a pet collides with the feeding bin 2, it will cause the feeding bin 2 to bounce back and forth, and the continuous elastic shaking will cause the pet food in the feeding bin 2 to continuously flow out of the food leakage hole 21. Such design can train pets to touch and shake the feeding bin 2 through their mouths or claws, replenishing the pet food into the food tray 1, thereby increasing fun and also exercising their intelligence.

The elastic post 101 includes a locking portion 102 to stably fix the feeding bin 2. The locking portion 102 can be obtained by setting convex bars, for example, two convex bars are designed on top and bottom of the elastic post 101, to form a concave groove structure between the two convex bars. An edge of the hole position 200 of the feeding bin 2 is just embedded into the groove structure.

The feeding bin 2 includes a baffle 23 adapted to the food leakage hole 21. The baffle 23 is provided to open or close the food leakage hole 21, so that the feeding bin 2 can be more convenient to be used.

There is a plurality of ways to set the baffle 23. For example, there si a plurality of food leakage holes 21 with different sizes; the baffle 23 corresponding to each food leakage hole 21 is a disposable design and connected to the food leakage hole 21 through a fragile wire. Due to a variety of categories and differences in sizes and shapes of pet food, the plurality of food leakage holes 21 with different sizes can be set up. The baffle 23 is a disposable design, so that consumers can choose to disassembly the baffles 23 of some food leakage holes 21, so as to better adapt to the flow of pet food. There is a plurality of options for designing the baffle 23 at once, such as several spacing holes being designed between the edge of the baffle 23 and an inner wall of the food leakage hole 21, or a thinner size being designed a the edge of the baffle 23.

The baffle 23 is connected to a circular member 24 slidably sleeved around an outer of the elastic post 101. Preferably, the plurality of food leakage holes 21 can be set at the bottom of the feeding bin 2, and distributed around the inserting holes 22 correspondingly, while the circular member 24 is surrounded and connected with the plurality of baffles 23 to cover corresponding food leakage holes 21. When the feeding bin 2 is installed on the elastic post 101 and the baffle 23 needs to be opened, the circular member 24 moves downwardly along the elastic post 101. When the food leakage hole 21 of the feeding bin 2 needs to be closed, the circular member 24 moves upwardly along the elastic post 101. There is no need to remove the feeding bin 2 from the elastic post 101 before proceeding with the operation, which is very simple. The baffle 23 and the food leakage hole 21 can also be strengthened by limiting modes such as convex bars to enhance firmness therebetween.

In order to prevent pets from directly consuming the food within the feeding bin 2, it is necessary to impose restrictions on the inlet 20 of the feeding bin 2. For example, the size of the inlet 20 is smaller than what the pet needs to eat. The shape of the inlet 20 can be varied, such as a simple pore structure, which can be circular, square and polygonal, etc., or shapes as shown in FIG. 1 and FIG. 3, the inlet 20 is arranged on the top surface of the feeding bin 2. The inlet 20 includes a hole position 200 formed at a middle of the inlet 20, and a plurality of wiring grooves 201 radiating towards the periphery of the hole position 200.

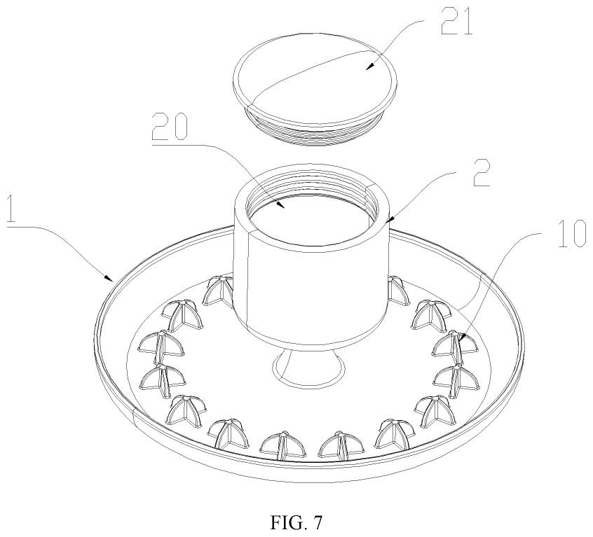

The pet slow food tableware further includes a cover 21 covered on the inlet 20. As shown in FIG. 6 and FIG. 7, the inlet 20 is set relatively large. The whole top of the feeding bin 2 is set as the inlet 20, and the cover 20 is installed on the inlet 20 by threads, tight fitting and buckles. When adding pet food to the feeding bin 2, the cover 21 first opens to add pet food into the feeding bin 2, and then covers on the inlet 20, which can prevent pet food from flowing out of the inlet 20 and obtain a better storage environment, and effectively prevent pets from directly consuming the food within the feeding bin 2.

Each of the plurality of protrusions 10 includes two arc plates 100 crossed to each other. An intersection angle between the two arc plates 100 is not limited and can be within a range of 30-60 degrees. The two arc plates 100 not only interferes with pet eating, but also provides a comfortable touch without scratching the pet's tongue.

A plurality of sucking discs 103 is formed at an outer bottom surface of the food tray 1. The slow food tableware of the present disclosure can be fixed on a plane through the plurality of sucking discs 103, which can effectively prevent the slow food tableware from being tipped over during pet eating food.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A pet slow food tableware comprising:
a food tray comprising a body configured to receive pet food for pets, and a plurality of protrusions formed at an inner surface of the body; and
a feeding bin installed above the food tray and comprising a receiving room for receiving the food to be put in, wherein the feeding bin comprises an inlet so that pet food can be added to the feeding bin from the inlet, and a food leakage hole formed on a bottom of the feeding bin so that the food is to flow out of the feeding bin to the food tray.

2. The pet slow food tableware as claimed in claim 1, wherein the body of the food tray comprises an elastic post extending upwardly from a bottom of the feeding bin.

3. The pet slow food tableware as claimed in claim 2, wherein an inserting hole is formed on the bottom of the feeding bin so that the elastic post inserts into the inserting hole; and the elastic post comprises a locking portion to stably fix the feeding bin.

4. The pet slow food tableware as claimed in claim 2, wherein the feeding bin comprises a baffle adapted to the food leakage hole.

5. The pet slow food tableware as claimed in claim 4, wherein the feeding bin comprises a plurality of food leakage holes with different sizes; and
the baffle corresponding to each of the plurality of food leakage holes is a disposable design and connected to the corresponding food leakage hole through a fragile wire.

6. The pet slow food tableware as claimed in claim 4, wherein the baffle is connected to a circular member slidably sleeved around an outer of the elastic post.

7. The pet slow food tableware as claimed in claim 1, wherein a size of the inlet is less than a size that is required for feeding pets.

8. The pet slow food tableware as claimed in claim 7, wherein the inlet is formed on a top surface of the feeding bin, the inlet comprising a hole position formed at a middle of the inlet, and a plurality of wiring grooves radiating towards the periphery of the hole position.

9. The pet slow food tableware as claimed in claim 1, wherein the pet slow food tableware further comprises a cover covered on the inlet.

10. The pet slow food tableware as claimed in claim 1, wherein each of the plurality of protrusions comprises two arc plates crossed to each other.
